(19) United States
(12) Patent Application Publication
(10) Pub. No.: US 2021/0408619 A1
(43) Pub. Date: Dec. 30, 2021

(54) HEAT EXCHANGE INTERFACE AND A METHOD OF CONFIGURING THE SAME

(71) Applicant: Valeo North America, Inc., Auburn Hills, MI (US)

(72) Inventor: Raul Walls, Troy, MI (US)

(73) Assignee: Valeo North America, Inc., Auburn Hills, MI (US)

(21) Appl. No.: 16/916,707

(22) Filed: Jun. 30, 2020

(51) Int. Cl. H01M 10/653; H01M 10/6556

(52) U.S. Cl. CPC H01M 10/653; B60L 58/26; H01M 10/6556

(57) ABSTRACT

A heat exchange interface (100) includes a thermally conductive substrate (10), at least one blister of dielectric material (20) and an adhesive layer (30). The thermally conductive substrate (10) includes at least one of channel and tubes (12) configured on a first mating surface (14) thereof. The at least one blister of dielectric material (20) includes at least one mating surface (24) that is complimentary to and that mates with the first mating surface (14) of the thermally conductive substrate (10). The adhesive layer (30) is applied to the mating surface (14, 24) of either one of the thermally conductive substrate (10) and the at least one blister of dielectric material (20) after increasing surface tension thereof to configure connection between the mating surfaces (14,24) of the thermally conductive substrate (10) and the at least one blister of dielectric material (20).

### FIELD OF THE INVENTION

The present invention relates to an interface between high performance electrochemical devices, such as, batteries and capacitors, and a heat exchanger for extracting and dissipating heat from such devices.

### BACKGROUND

With the development of electric vehicles and advantages thereof over conventional vehicle driven by internal combustion engine, electric vehicles are preferred over the conventional vehicle operating on internal combustion engine. One of the main challenge faced with the use of electric vehicles is thermal management of batteries that impacts maintaining energy storage capacity, driving range, cell longevity of the battery and that also impacts system safety. More specifically, in case of battery management system for a battery for an electric vehicle, electrical insulation along with thermal conductivity is required to achieve efficient heat dissipation and ensuring safe operating conditions. Generally, indirect contact liquid cooling is used instead of other cooling methods, such as air-cooling and phase change material cooling. For indirect-contact liquid cooling, either a jacket or a cold plate with discrete tubing or channels formed thereon either receives or is in contact at least a portion of the battery module to extract heat from the battery. A coolant flows through the tubing or the channels to dissipate the heat generated by the battery and transferred to the cold plate or jacket. Although, the indirect contact liquid cooling methods are used to prevent electrical conduction with the cells of the battery while maintaining high thermal conductivities for efficient heat transfer for battery cooling. However, the conventional indirect-contact liquid cooling still involves safety issues such as risks of short-circuiting. Further, the conventional indirect-contact liquid cooling systems also face other issues such as inefficient heat transfer due to gaps or insufficient surface contact at the interface between the battery and the jacket or the cold plate of the indirect contact liquid cooling system due to complex surface profile of the cold plate. The inefficient heat transfer at the interface results in inefficient cooling of the battery, thereby detrimentally impacting efficiency and performance of the battery.

Accordingly, there is a need for a heat exchange interface between a battery and a thermal plate or jacket of an indirect contact liquid cooling system for the battery that ensures sufficient contact at interface in spite of complex surface profile of the thermal plate to achieve efficient heat transfer and battery cooling. Further, there is a need for a heat exchange interface configured between a battery and a thermal plate or jacket of an indirect contact liquid cooling system that improves performance of the battery by efficient thermal management of the battery. Furthermore, there is a need for a heat exchange interface that prevents electrical conduction at the interface with the cells of the battery while maintaining high thermal conductivities for efficient heat transfer for battery cooling. Still further, there is a need for a heat exchange interface configured between a battery and a thermal plate or jacket of an indirect contact liquid cooling system for the battery that improves reliability of the battery and the battery requires reduced maintenance.

### SUMMARY OF THE INVENTION

An object of the present invention is to provide a heat exchange interface configured between a battery and a thermal plate or a jacket of an indirect contact liquid cooling system for the battery that obviates the drawbacks associated conventional heat exchange interfaces of the indirect contact liquid cooling systems.

Another object of the present invention is to provide a heat exchange interface between a battery and a thermal plate or a jacket of an indirect contact liquid cooling system for the battery that ensures sufficient surface contact at the interface in spite of complex surface profile of the thermal plate to achieve efficient heat transfer and efficient battery cooling.

Yet another object of the present invention is to provide a heat exchange interface configured between a battery and a thermal plate or a jacket of an indirect contact liquid cooling system for the battery that improves performance of the battery by efficient thermal management of the battery.

Still another object of the present invention is to provide a heat exchange interface configured between a battery and a thermal plate or a jacket of an indirect contact liquid cooling system for the battery that improves reliability and service life of the battery and the maintenance of the battery is reduced.

Another while object of the present invention is to provide a heat exchange interface configured between a battery and a thermal plate or a jacket of an indirect contact liquid cooling system for the battery that prevents electrically conductive contact of the interface with cells of the battery, while still maintaining high thermal conductivities for efficient heat transfer for battery cooling.

Another object of the present invention is to provide a transparent blister of dielectric material. This embodiment enable an easier air gap detection between the blister and the thermally conductive substrate.

In one aspect of the invention, the adhesive can be applied by either spraying or rolling or any other suitable technic.

In one aspect of the invention, the thermally conductive substrate can be made of an aluminum plate formed by stamping, laser cut, hydro forming or any other suitable means.

In the present description, some elements or parameters may be indexed, such as a first element and a second element. In this case, unless stated otherwise, this indexation is only meant to differentiate and name elements which are similar but not identical. No idea of priority should be inferred from such indexation, as these terms may be switched without betraying the invention. Additionally, this indexation does not imply any order in mounting or use of the elements of the invention.

A heat exchange interface, hereinafter referred to as “interface” is disclosed in accordance with an embodiment of the present invention. The interface includes a thermally conductive substrate, at least one blister of dielectric material and an adhesive. The thermally conductive substrate includes a first mating surface that forms a portion of at least one of channels and tubes. The at least one blister of dielectric material includes at least one second mating surface that is complimentary to and that mates with the first mating surface of the thermally conductive substrate. The adhesive applied to the mating surface of either one of the thermally conductive substrate and the at least one blister of dielectric material after increasing surface tension thereof, so that the adhesive is uniformly distributed over the mating surface to configure connection between the mating surfaces.

Specifically, the thermally conductive substrate is a part of a chiller and the at least one of channels and tubes receive coolant therein.

Generally, the thermally conductive substrate is of aluminum.

In accordance with an embodiment of the present invention, the thermally conductive substrate is formed by stamping.

Specifically, the at least one blister of dielectric material is of High Density Polyethylene (HDPE).

In accordance with an embodiment of the present invention, the at least one blister of dielectric material is formed by thermoforming.

Specifically, the mating surface of either one of the thermally conductive substrate and the at least one blister of dielectric material is subjected to corona treatment before application of the adhesive thereto.

In accordance with an embodiment of the present invention, the mating surfaces of at least one of the thermally conductive substrate and the at least one blister of dielectric material is configured with poke-yoke features to ensure that the mating surfaces are aligned with each other while being connected by the adhesive.

Further, at least a portion of either one of the thermally conductive substrate and the at least one blister of dielectric material is masked to prevent application of the adhesive thereon to prevent formation of connection there-between at that portion.

Also is disclosed a chiller in accordance with an embodiment of the present invention, wherein at least a portion of the chiller is configured by a thermally conductive substrate that forms a part of a heat exchange interface between the chiller and a battery cooled by the chiller, characterized in that heat exchange interface is as disclosed above.

A method for configuring a heat exchange interface is disclosed in accordance with an embodiment of the present invention. The method includes the steps of forming a thermally conductive substrate, wherein a first mating surface thereof forms a portion of channels and tubes, forming at least one blister of dielectric material such that at least one mating surface thereof is complimentary to the first mating surface of the thermally conductive substrate. Thereafter, treating the mating surface of either one of the thermally conductive substrate and the at least one blister of dielectric material for increasing surface tension at the mating surface. Subsequently, applying an adhesive so that the adhesive is uniformly distributed over either one of the mating surface of the thermally conductive substrate and the at least one blister of dielectric material for configuring connection between the mating surfaces. Finally, removing air gaps in at least one of the adhesive and the at least one blister of dielectric material by applying vacuum.

Generally, the step of forming the thermally conductive substrate is performed by stamping.

Preferably, the step of forming at least one blister of dielectric material is performed by thermo-forming.

Specifically, the step of treating the mating surface of either one of the thermally conductive substrate and the at least one blister of dielectric material for increasing surface tension at the mating surface is performed by subjecting the mating surface to at least one of corona treatment and any other surface treatment process.

Further, the method for configuring a heat exchange interface includes the step of heating the adhesive before application thereof to the mating surface of either one of the thermally conductive substrate and the at least one blister of dielectric material for uniformly distributing the adhesive over the mating surface.

Generally, the step of applying adhesive to at least one of the mating surface of the thermally conductive substrate and the at least one blister of dielectric material is performed by spraying the adhesive over the mating surface.

Further, the method for configuring a heat exchange interface includes a step of detecting air gaps in at least one of the adhesive and the at least one blister of dielectric material performed before the step of removing the air gaps.

Generally, the step of detecting air gaps in the blister of dielectric material is performed by visual inspection, as the at least one blister of dielectric material is of translucent material.

Specifically, the step of detecting air gaps in the adhesive is performed by an Ultraviolet probe.

### BRIEF DESCRIPTION OF THE DRAWINGS

Other characteristics, details and advantages of the invention can be inferred from the description of the invention hereunder. A more complete appreciation of the invention and many of the attendant advantages thereof will be readily obtained as the same becomes better understood by reference to the following detailed description when considered in connection with the accompanying figures, wherein:

FIG. 1 illustrates a schematic representation of a heat exchange interface in accordance with an embodiment of the present invention, also is provided a schematic representation of an enlarged view depicting connection between various elements configuring the heat exchange interface; and

FIG. 2 illustrates a block diagram depicting various steps involved in configuring the heat exchange interface of FIG. 1.

It must be noted that the figures disclose the invention in a detailed enough way to be implemented, said figures helping to better define the invention if needs be. The invention should however not be limited to the embodiment disclosed in the description.

### DETAILED DESCRIPTION

The present invention envisages a heat exchange interface that includes a thermally conductive substrate, at least one blister of dielectric material and an adhesive. In the forthcoming description, the heat exchange interface of the present invention is explained for use in chiller for battery cooling of an electric vehicle. The heat exchange interface of such configuration ensures sufficient contact between the thermally conductive substrate and the blister of dielectric material in spite of complex surface profile of the thermally conductive substrate to achieve efficient heat conductivity at the interface for efficient battery cooling. Further, the blister of dielectric material configuring a part of the heat exchange interface of the present invention prevents electrical conduction through the heat exchange interface to prevent short-circuit and addresses safety issues. However, the present invention is also applicable for configuring an interface that involves any substrate with complex surface profile and a coating to be applied over the substrate, wherein sufficient surface contact and secure connection is required between the substrate and the coating.

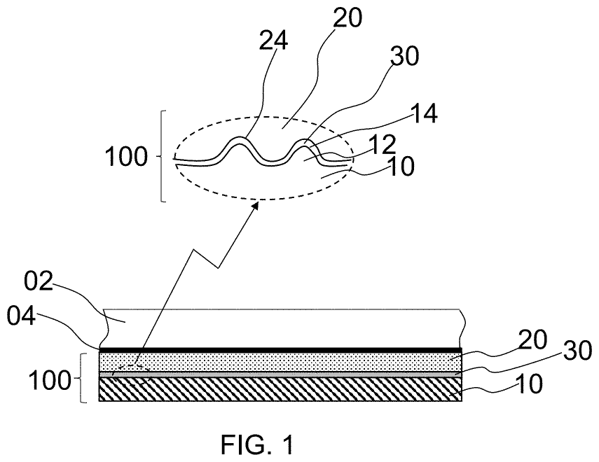

FIG. 1 illustrates a schematic representation of a heat exchange interface 100 in accordance with an embodiment of the present invention. The heat exchange interface 100 includes a thermally conductive substrate 10, at least one blister of dielectric material 20 and an adhesive 30. The thermally conductive substrate 10 is configured either in form of a thermal plate or a thermal jacket and is capable of extracting heat from an exterior wall of a battery 02 through thermal conduction. More specifically, a thermal glue 04, the at least one blister of dielectric material 20 and the adhesive 30 disposed in sequence between the jacket or thermal plate formed of the thermally conductive substrate 10 and the battery 02 permit heat transfer there-through. Particularly, the at least one blister of dielectric material 20 permits heat transfer there through to permit the transfer of thermal energy from the exterior wall of the battery 02 to the thermal plate formed of the thermally conductive substrate 10. However, the at least one blister of dielectric material 20 still prevents transfer of electrical energy there through to prevent transfer of electrical energy from the battery to the thermal plate formed of the thermally conductive substrate 10. The thermally conductive substrate 10 includes discrete tubing or channels formed thereon, through which a coolant flows for dissipation of thermal energy extracted by the thermally conductive substrate 10 from the exterior wall of the battery 02.

The thermally conductive substrate 10 includes a first mating surface 14 that transfers thermal energy received from the battery 02 to the coolant flowing through the channels and the tubing. For efficient heat transfer, the channels and the tubing are formed as close as possible to the first mating surface 14 and accordingly the first mating surface 14 has complex surface configuration. In accordance with an embodiment of the present invention, the thermally conductive substrate 10 is of aluminum. In accordance with an embodiment of the present invention, the thermally conductive substrate 10 is of aluminum and is formed by stamping. However, the present invention is not limited to any particular configuration, method of manufacturing and material of the thermally conductive substrate 10 as long as the thermal plate or the thermal jacket configured of the thermally conductive substrate 10 is capable of extracting heat from an exterior wall of the battery 02 through thermal conduction.

The at least one blister of dielectric material 20 includes at least one second mating surface 24 that is complimentary to and mates with the first mating surface 14 of the thermally conductive substrate 10. The at least one blister of dielectric material 20 is of High Density Polyethylene (HDPE). The at least one blister of dielectric material 20 is formed by thermoforming. However, the present invention is not limited to any particular configuration, method of manufacturing and material of the at least one blister of dielectric material 20, as long as the at least one blister of dielectric material 20 exhibits thermal conductivity with electrical insulation and is capable of being so configured that the at least one mating surface 24 thereof is complimentary to and mates with the first mating surface 14 of the thermally conductive substrate 10.

The adhesive 30 is applied to the mating surface 14, 24 of either one of the thermally conductive substrate 10 and the at least one blister of dielectric material 20 after increasing surface tension at the mating surface 14, 24. The adhesive 30 is such that the adhesive 30 is capable of transmitting thermal energy there through. In accordance with an embodiment of the present invention, the mating surface 14, 24 of either one of the thermally conductive substrate 10 and the at least one blister of dielectric material 20 is subjected to corona treatment. However, the present invention is not limited to any particular surface treatment process for improving surface tension of the mating surface 14, 24 before application of the adhesive 30 thereto. With such surface treatment, the surface tension of the mating surface 14, 24 of either one of the thermally conductive substrate 10 and the at least one blister of dielectric material 20 is improved. Accordingly, the adhesive 30 is uniformly distributed over the mating surface 14, 24 and enables better surface contact with at least one of the mating surface 14, 24 to configure secure connection between the mating surfaces 14, 24 of the thermally conductive substrate 10 and the at least one blister of dielectric material 20. Such a configuration enables sufficient contact of the adhesive with at least one of the mating surface 14, 24 of the thermally conductive substrate 10 and the at least one blister of dielectric material 20, thereby ensuring connection between the mating surface 14, 24 of the thermally conductive substrate 10 and the at least one blister of dielectric material 20 respectively, in spite of the complex surface configuration of the mating surface 14 of the thermally conductive substrate 10.

In accordance with an embodiment of the present invention, the mating surfaces 14, 24 of at least one of the thermally conductive substrate 10 and the at least one blister of dielectric material 20 is configured with poke-yoke features to ensure that the mating surfaces 14, 24 are aligned with each other while being connected by the adhesive 30. In accordance with another embodiment of the present invention, at least a portion of either one of the thermally conductive substrate 10 and the at least one blister of dielectric material 20 is masked to prevent application of the adhesive 30 thereon to prevent formation of connection there-between at that portion that is masked.

A chiller 300 is disclosed in accordance with an embodiment of the present invention. At least a portion of the chiller 300, particularly, a thermal plate thereof is configured by a thermally conductive substrate 10. The thermally conductive substrate 10 also forms a part of a heat exchange interface 100 between the chiller 300 and a battery 02 cooled by the chiller 300, characterized in that the heat exchange interface 100 as disclosed hereinabove.

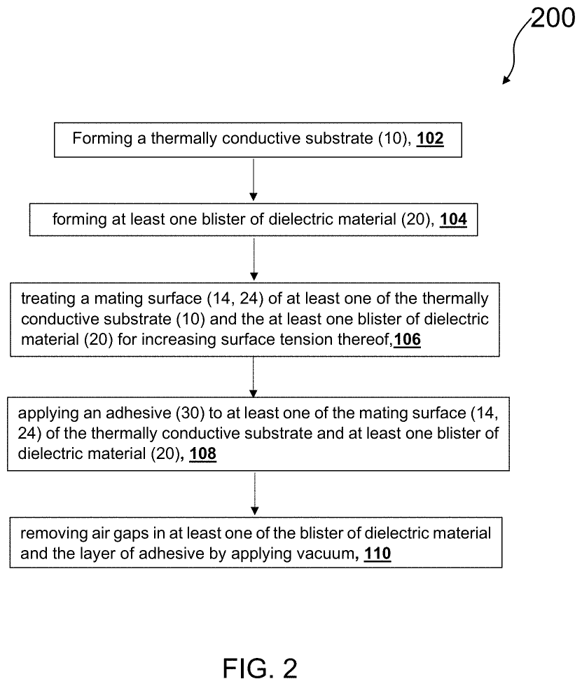

A method 200 for configuring a heat exchange interface 100 is also disclosed in accordance with an embodiment of the present invention. FIG. 2 illustrates a block diagram depicting the various steps of the method 200 for configuring the heat exchange interface 100. Although, the various steps of the method 200 are depicted by blocks in the block diagram and any number of steps described as method blocks can be combined in any order or can be performed in parallel to employ the method 200, or an alternative method. Additionally, individual blocks may be deleted from the block diagram depicting the method without departing from the scope and ambit of the present invention. The method 200 is to be understood with reference to the following description along with the FIG. 2.

The method 200 includes a step 102 of forming a thermally conductive substrate 10, wherein a first mating surface 14 thereof forms a portion of channels and tubes 12. The step 102 of forming the thermally conductive substrate 10 is performed by stamping. Simultaneously, forming at least one blister of dielectric material 20 in a step 104 such that at least one mating surface 24 thereof is complimentary to the first mating surface 14 of the thermally conductive substrate 10. The step 104 of forming the at least one blister of dielectric material 20 is performed by thermo-forming. Thereafter, treating the mating surface 14, 24 of either one of the thermally conductive substrate 10 and the at least one blister of dielectric material 20 in step 106 for increasing surface tension at the mating surface 14, 24. The step 106 of treating the mating surface 14, 24 of either one of the thermally conductive substrate 10 and the at least one blister of dielectric material 20 for increasing surface tension at the mating surface 14, 24 is performed by subjecting the mating surface 14, 24 to corona treatment. However, the present invention is not limited to any particular surface treatment process for improving surface tension of either one of the mating surface 14, 24 before application of an adhesive 30 thereto. With such surface treatment, the surface tension of the mating surface 14, 24 of either one of the thermally conductive substrate 10 and the at least one blister of dielectric material 20 is improved. Accordingly, the adhesive 30 can be uniformly applied and distributed over the mating surface 14, 24 to enable better surface contact with the mating surface 14, 24 and to configure secure connection between the mating surfaces 14, 24 of the thermally conductive substrate 10 and the at least one blister of dielectric material 20. Subsequently, applying the adhesive 30 so that the adhesive 30 is uniformly distributed over either one of the mating surface 14, 24 of the thermally conductive substrate 10 and the at least one blister of dielectric material 20. The uniform application of the adhesive over either one of the mating surface 14, 24 enables better surface contact of the adhesive with the mating surface 14, 24 for configuring secure connection between the mating surfaces 14, 24. The step 108 of applying the adhesive 30 to at least one of the mating surface 14, 24 of the thermally conductive substrate 10 and the at least one blister of dielectric material 20 is performed by spraying the adhesive over the mating surface 14, 24. However, the present invention is not limited to any particular method of applying the adhesive over the mating surface 14, 24. Finally, removing air gaps in at least one of the adhesive 30 and the at least one blister of dielectric material 20 by applying vacuum in step 110. The step of removing the air gaps in the at least one blister of dielectric material 20 and the adhesive 30 ensures high thermal conductivity of the at least one blister of dielectric material 20 and the adhesive 30 configuring the heat exchange interface 100 as the air bubbles detrimentally impact the thermal conductivity thereof.

The method 300 further include the step of heating the adhesive 30 before being applied to the mating surface 14, 24 of either one of the thermally conductive substrate 10 and the at least one blister of dielectric material 20 for uniformly distributing the adhesive 30 over the mating surface 14, 24. The method 300 further includes a step 112 of detecting air gaps in at least one of the adhesive 30 and the at least one blister of dielectric material 20. The step 112 of detecting air gaps is performed before the step 110 of removing the air gaps. The step 112 of detecting air gaps in the at least one blister of dielectric material 20 is performed by visual inspection, as the at least one blister of dielectric material 20 is of translucent material. The step 112 of detecting the air gaps in the adhesive 30 is performed by an Ultraviolet probe. However, the present invention is not limited to any particular method for detecting the air gaps in the at least one blister of dielectric material 20 and the adhesive 30.

Several modifications and improvement might be applied by the person skilled in the art to a heat exchange interface 100 and a method 200 for configuring the heat exchange interface 100 as defined above, and such modifications and improvements will still be considered within the scope and ambit of the present invention, as long as the system comprises a thermally conductive substrate, at least one blister of dielectric material and an adhesive. The thermally conductive substrate includes a first mating surface that forms a portion of at least one of channels and tubes. The at least one blister of dielectric material includes at least one second mating surface that is complimentary to and that mates with the first mating surface of the thermally conductive substrate. The adhesive applied to the mating surface of either one of the thermally conductive substrate and the at least one blister of dielectric material after increasing surface tension thereof, so that the adhesive is uniformly distributed over the mating surface to configure connection between the mating surfaces.

Obviously, numerous modifications and variations of the present invention are possible in light of the above teachings. It is therefore to be understood that the invention may be practiced otherwise than as specifically described herein.

In any case, the invention cannot and should not be limited to the embodiments specifically described in this document, as other embodiments might exist. The invention shall spread to any equivalent means and any technically operating combination of means.

What is claimed is:

1. A heat exchange interface comprising:
a thermally conductive substrate, wherein a first mating surface of the thermally conductive substrate is adapted to form a portion of at least one of channels and tubes of the thermally conductive substrate;
at least one blister of dielectric material comprising at least one second mating surface complimentary to and adapted to mate with the first mating surface of the thermally conductive substrate; and
an adhesive configured to be applied to the first or second mating surface of either one of the thermally conductive substrate and the at least one blister of dielectric material after increasing surface tension thereof, so that the adhesive is uniformly distributed over the first or second mating surface to configure connection between the first and second mating surfaces.

2. The heat exchange interface as claimed in claim 1, wherein the thermally conductive substrate is a part of a chiller and the at least one of channels and tubes are adapted to receive coolant therein.

3. The heat exchange interface as claimed in claim 1, wherein the thermally conductive substrate is made of aluminum.

4. The heat exchange interface as claimed in claim 1, wherein the thermally conductive substrate is formed by stamping.

5. The heat exchange interface as claimed in claim 1, wherein the at least one blister of dielectric material is of High Density Polyethylene (HDPE).

6. The heat exchange interface as claimed in claim 1, wherein the at least one blister of dielectric material is formed by thermoforming.

7. The heat exchange interface as claimed in claim 1, wherein the first or second mating surface of either one of the thermally conductive substrate and the at least one blister of dielectric material is subjected to at least one of corona treatment and other surface treatment for improving surface tension before application of the adhesive thereto.

8. The heat exchange interface as claimed in claim 1, wherein the first and second mating surfaces of at least one of the thermally conductive substrate and the at least one blister of dielectric material is configured with poke-yoke features to ensure that the first and second mating surfaces are aligned with each other while being connected by the adhesive.

9. The heat exchange interface as claimed in claim 1, wherein at least a portion of either one of the thermally conductive substrate and the at least one blister of dielectric material is masked to prevent application of the adhesive thereon to prevent formation of connection there-between at that portion.

10. A chiller, wherein at least a portion of the chiller is configured by a thermally conductive substrate that forms a part of a heat exchange interface between the chiller and a battery cooled by the chiller, wherein the heat exchange interface comprises:
a thermally conductive substrate, wherein a first mating surface of the thermally conductive substrate is adapted to form a portion of at least one of channels and tubes of the thermally conductive substrate,
at least one blister of dielectric material comprising at least one second mating surface complimentary to and adapted to mate with the first mating surface of the thermally conductive substrate, and
an adhesive configured to be applied to the first or second mating surface of either one of the thermally conductive substrate and the at least one blister of dielectric material after increasing surface tension thereof, so that the adhesive is uniformly distributed over the first or second mating surface to configure connection between the first and second mating surfaces.

11. A method for configuring a heat exchange interface comprising the steps of:
forming a thermally conductive substrate, wherein a first mating surface thereof is adapted to form a portion of channels and tubes;
forming at least one blister of dielectric material such that at least one mating surface thereof is complimentary to the first mating surface of the thermally conductive substrate;
treating the mating surface of either one of the thermally conductive substrate and the at least one blister of dielectric material for increasing surface tension at the mating surface;
applying an adhesive in a uniformly distributed manner over either one of the mating surfaces of the thermally conductive substrate and the at least one blister of dielectric material for configuring connection between the mating surfaces; and
removing air gaps in at least one of the adhesive and the at least one blister of dielectric material by applying a vacuum.

12. The method as claimed in claim 11, wherein forming the thermally conductive substrate is performed by stamping.

13. The method as claimed in claim 11, wherein forming the at least one blister of dielectric material is performed by thermo-forming.

14. The method as claimed in claim 11, wherein treating the mating surface of either one of the thermally conductive substrate and the at least one blister of dielectric material for increasing surface tension at the mating surface is performed by subjecting the mating surface to at least one of corona treatment and any other surface treatment process.

15. The method as claimed in claim 11, further comprising: heating the adhesive before application to the mating surface of either one of the thermally conductive substrate and the at least one blister of dielectric material for uniformly distributing the adhesive over the mating surface.

16. The method as claimed in claim 11, wherein applying the adhesive to at least one of the mating surface of the thermally conductive substrate and the at least one blister of dielectric material is performed by spraying the adhesive over the mating surface.

17. The method as claimed in claim 11, further comprising: detecting air gaps in at least one of the adhesive and the at least one blister of dielectric material before removing the air gaps.

18. The method as claimed in claim 11, wherein detecting air gaps in the at least one blister of dielectric material is performed by visual inspection, as the at least one blister of dielectric material is of translucent material.

19. The method as claimed in claim 11, wherein detecting the air gaps in the adhesive is performed by an Ultraviolet probe.
